(19) United States
(12) Patent Application Publication
(10) Pub. No.: US 2015/0134379 A1
(43) Pub. Date: May 14, 2015

(54) Singularity of Presence

(71) Applicant: International Business Machines Corporation, Armonk, NY (US)

(72) Inventor: Jeffrey J. Jonas, Las Vegas, NV (US)

(73) Assignee: International Business Machines Corporation, Armonk, NY (US)

(21) Appl. No.: 14/080,229

(22) Filed: Nov. 14, 2013

(51) Int. Cl. G06Q 10/06

(52) U.S. Cl. CPC G06Q 10/063
USPC 705/7.11

(57) ABSTRACT

Methods and apparatus, including computer program products, implementing and using techniques for processing data. A first spacetime event observation is received. A second spacetime event observation is received. A singularity of presence indicator is received for a zone of space and a range of time corresponding to one or more of: the first spacetime event observation and the second spacetime event observation. It is determined whether the first spacetime event observation and the second spacetime event observation belong to a same entity using the singularity of presence indicator.

### BACKGROUND

The present invention relates to data analysis, and more specifically, to spatial and temporal analytics. Spatial and temporal analytics allow entities to be associated with space and time data. Some spatial and temporal analytics generalize space and time e.g., the conversion of space and time into a feature known as a SpaceTimeBox (STB). An STB reflects a spatial region and a time interval, at a specific granularity. Any event, that is, any point in spacetime specified by its time and place, can be assigned to at least one STB. When an entity is associated with an event, other entities occupying the same STB can be located. Entities with STB's can be compared using the their respective STB's as well as any other feature these entities may have such as lengths, license plate numbers, colors, etc. The unit size of space and time are configurable parameters, set based on various conditions. In the context of STB's, one density could be 610 meters of space and 15 minutes, for example.

There are many cases in which it would be advantageous to determine whether two entity detections—separated across different data sources (also referred to as “channels”) or from the same data source though separated by time—are in fact the same entity. While at some density STBs can in themselves be used as a proxy to determine two observed entities are the same, there are also situations in which this technique cannot be applied. For example, it may be difficult or even impossible to determine from STB data alone whether there are two people in the back of a taxi, who each have their own cellphone, or whether there is only a single person who is carrying two cellphones. Similarly, there may be signals from two cellphones emanating from the space in front of an ATM machine, and the granularity of the STBs may not be sufficient to say if this is one person (i.e., entity) carrying two cellphones, or two people waiting in line, each having their own cell phone. Thus, there is a need for improved techniques for disambiguating entities (asserting same and different) in such circumstances.

### SUMMARY

According to one embodiment of the present invention, methods and apparatus, including computer program products, are provided implementing and using techniques for processing data. A first spacetime event observation is received. A second spacetime event observation is received. A singularity of presence indicator is received for a zone of space and a range of time corresponding to one or more of: the first spacetime event observation and the second spacetime event observation. It is determined whether the first spacetime event observation and the second spacetime event observation belong to a same entity using the singularity of presence indicator

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 shows a schematic of an example of an entity analytics system for disambiguating entities by using singularity of presence, in accordance with one embodiment.

FIG. 2 shows a schematic example of a computing node, in accordance with one embodiment.

FIG. 3 shows a flowchart of a process for disambiguating entities based on singularity of presence indicators, in accordance with one embodiment.

Like reference symbols in the various drawings indicate like elements.

### DETAILED DESCRIPTION

### Overview

The various embodiments described herein pertain to improved techniques for disambiguating entities in situations where space and time alone is insufficient for making such a determination. Some data sources provide geospatial coordinates with a high degree of imprecision (sometimes thousands of meters of potential error). Other data sources are capable of presenting a number of discreet entities (e.g., an infrared image highlighting only one living, warm-bodied entity in the field of view). By combining these types of data streams, it is possible to assert the two observations, each with possibly wide error rates, are in fact one and the same. Various techniques for doing this will be explained in greater detail below. However, a few examples will first be given as an introduction and to further enhance the understanding of the underlying concepts of the various embodiments of the invention, and to explain the concept of “singularity of presence.”

### Example 1

You hear the noise of a jet engine (observation 1), you look up at the sky and see only one jet airplane (observation 2). By instinct, you automatically reconcile these two observations—knowing the jet made the sound—and conclude that there is only one entity with which the engine noise is associated. This notion of being aware of a single entity in this space will be referred to herein as “singularity of presence.” Note: even if there were a bird, a kite, a hot air balloon, and a jet in the field of view, the singularity of a class of entities would still inform the observer that the noise was made by the jet airplane, as birds, kites and hot air balloons do not make any noises of this kind.

### Example 2

At the beach you look out at the ocean and observe a single sailboat (observation 1). You look away for 5 minutes, and then you look back at the ocean. At that point you observe a single sailboat in a slightly different place (observation 2). Due to the singularity of presence you instinctually assert these two observations of sailboats actually pertain to the same sailboat (i.e., a single entity), even though you did not actually see the sailboat move. This is another example of singularity of presence.

### Example 3

Three roommates live in a house. You know that two of them are away on vacation and only one remains in the house (observation 1). Someone in the house is pushing the channel changer on the TV remote (observation 2). Here, singularity of presence would suggest that the person changing the channels is the third (at home) person, so the channel-changing event could be asserted to be the transactions of the third person.

### Example 4

You receive a first data record one representing an ATM swipe with a set of latitude/longitude coordinates representing where the ATM is located (observation 1). You receive a second data record representing a video taken by a security camera by the ATM at the time of the swipe (observation 2). Noting there is only one person present in the video at the time of the swipe (singularity of presence), it is reasonable to deduce that the ATM transaction was performed by the person (i.e., a single entity) in the captured video frame. On the other hand, if there were no singularity of presence (e.g., if there were three people present in the captured video frame at the time of the transaction, and they were all hovered together at the ATM), there would be no singularity of presence and no assertion of which entity in frame was the entity transaction.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented method such that the instructions which execute on the computer or other programmable apparatus provide processes for implementing the functions/acts specified in the flowcharts and/or block diagram block or blocks.

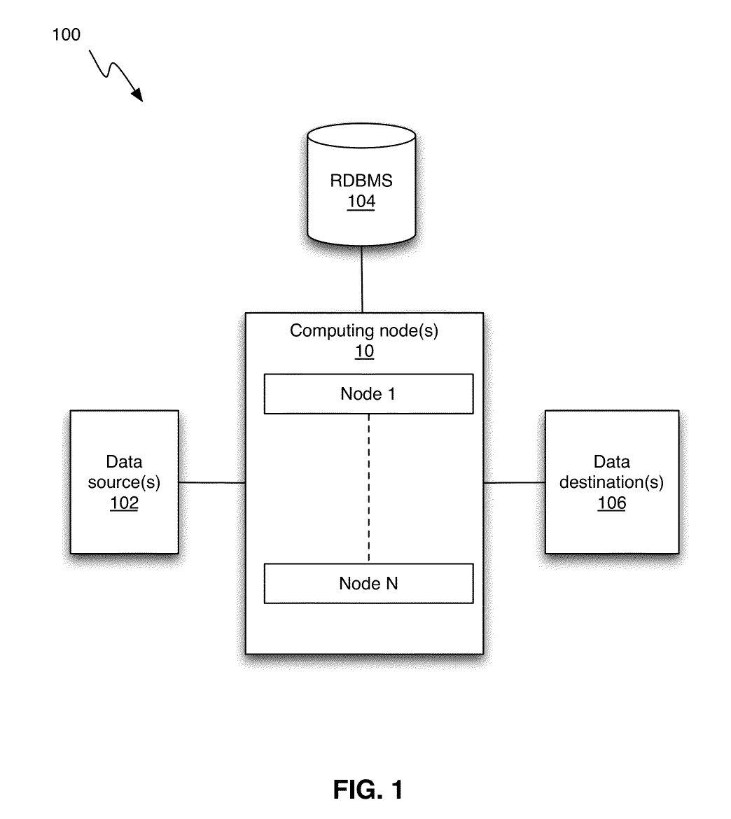

FIG. 1 shows a schematic of an example of an entity analytics system (100) used to disambiguate entities by using singularity of presence, in accordance with one embodiment. As can be seen in FIG. 1, the system (100) includes one or more computing nodes (10), which collaborate as will be described in further detail below to process data received in inbound messages from one or more data sources (102). Each node (10) can be an independent computer or processor that contributes to a larger task of performing the techniques described herein, for a given set of entities and events specified by the inbound messages from the data source(s) (102). Some examples of data sources (102) include telematics in a car reporting geolocation and time, a smart phone application collecting and reporting geolocation and time, a video from a parking lot set to collect from a specific location over time, space coordinates of an object in space, maritime vessel coordinates (AIS).

The nodes (10) are connected to a shared Relational Database Management System (RDBMS) (104), which can collect data from the nodes (10) and provide data to the nodes (10). The shared RDBMS (104) is only one example of a suitable basis for entity analytics processing and/or motion processing and is not intended to suggest any limitation as to the scope of use or functionality of embodiments of the invention described herein. The invention may be embodied, as otherwise described herein, without an RDBMS, for example by instead using an alternate form of storage or an entirely in-memory implementation. In an embodiment incorporating shared RDBMS (104), shared RDBMS (104) can contain, for example, data about data sources, observations, entities, features, and elements. A data source is typically a database table, a query, an extract from a system of record, or a sensor of events that occur in real time in a physical environment. An observation typically occurs when a record is added, changed, or deleted in a data source or when a physical event is observable via a sensor and may be represented by one or more records. An entity is typically associated with a particular type of record in a database table, such as a customer master record or a transaction record, and can reflect a physical object that may move through space over time and that may be represented by such a record. A feature is a particular piece of information about an entity. A feature may be represented by a group of fields that all describe aspects of the same thing. Many fields represent features all by themselves, but some can be grouped into a higher level. For instance, names and mailing addresses typically contain multiple fields or elements. An element is a further breakdown of a feature, such as the postal code that forms part of a typical address, and is typically represented by a field in a table.

By collecting this type of information in the shared RDBMS (104), the computing nodes (10) can work together to assert when two observations can be asserted to be coming from the same entity. The results of this assertion can be provided in an outbound message to one or more data destination(s) (106), which can be defined by a user, and be subsequently used, for example, in making business decisions of various kinds. For example, knowing what advertisement to place on the ATM or TV based on certainty of entity. Examples of data destinations include the shared RDBMS (104), a motion processing program or system, an entity analytics product, a user-readable spreadsheet for display, etc.

It should be realized that business decisions is merely one example of an area in which the techniques presented herein may be used, and that persons having ordinary skill in the art can easily come up with other alternative uses of the entity disambiguation. It should also be realized that while only one data source (102), one RDBMS (104) and one data destination (106) are illustrated in FIG. 1, in a real-life scenario, there may be multiple data sources (102), multiple (or zero) RDBMSs (104) and multiple data destinations (106) included in the entity analytics system (100).

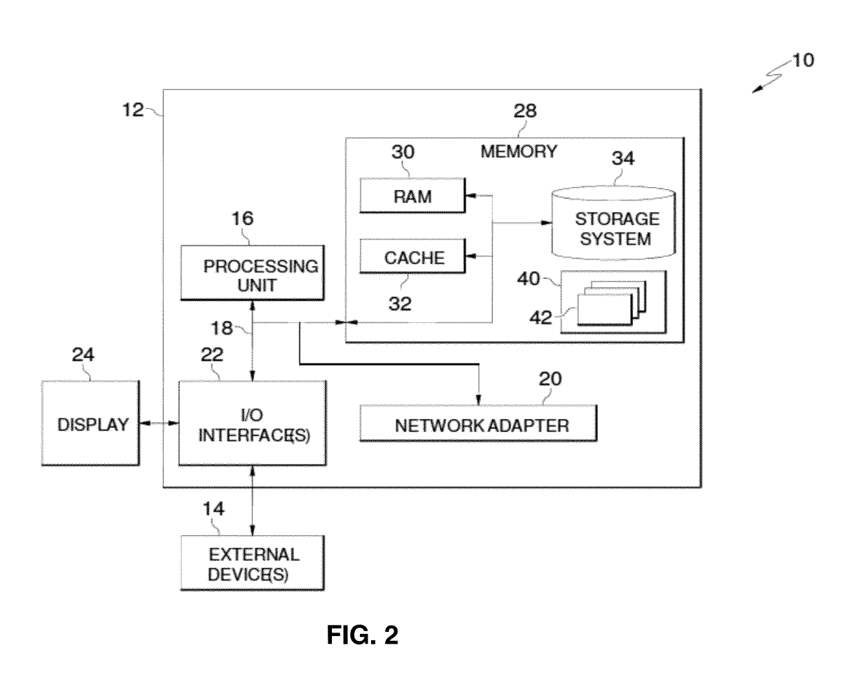

FIG. 2 shows a schematic example of a computing node (10). The computing node (10) is only one example of a suitable computing node and is not intended to suggest any limitation as to the scope of use or functionality of embodiments of the invention described herein. Regardless, the computing node (10) is capable of being implemented and/or performing any of the functionality set forth herein. In the computing node (10) there is a computing device (12). Examples of well-known computing devices include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed computing environments that include any of the above systems or devices, and the like.

The computing device (12) may be described in the general context of computer system executable instructions, such as program modules, being executed by a computer system. Generally, program modules may include routines, programs, objects, components, logic, data structures, and so on that perform particular tasks or implement particular abstract data types. The computing device (12) may be practiced in distributed cloud computing environments where tasks are performed by remote processing devices that are linked through a communications network. In a distributed cloud-computing environment, program modules may be located in both local and remote computer system storage media including memory storage devices.

As shown in FIG. 2, the computing device (12) in the computing node (10) is shown in the form of a general-purpose computing device. The components of the computing device (12) may include, but are not limited to, one or more processors or processing units (16), a system memory (28), and a bus (18) that couples various system components including system memory (28) to the processor (16).

The bus (18) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Peripheral Component Interconnect (PCI) bus, PCI Express bus, InfiniBand bus, HyperTransport bus, and Serial ATA (SATA) bus.

The computing device (12) typically includes a variety of computer system readable media. Such media may be any available media that is accessible by the computing device (12), and it includes both volatile and non-volatile media, and removable and non-removable media.

The system memory (28) can include computer system readable media in the form of volatile memory, such as random access memory (RAM) 30 and/or cache memory 32. The computing device (12) may further include other removable/non-removable, volatile/non-volatile computer system storage media. By way of example only, the storage system (34) can be provided for reading from and writing to a non-removable, non-volatile magnetic medium (not shown and typically called a “hard drive”). Although not shown, a magnetic disk drive for reading from and writing to a removable, non-volatile storage medium (e.g., a “USB flash drive”), and an optical disk drive for reading from or writing to a removable, non-volatile optical disk such as a CD-ROM, DVD-ROM or other optical media can be provided. In such instances, each can be connected to the bus (18) by one or more data media interfaces. As will be further depicted and described below, the memory (28) may include at least one program product having a set (e.g., at least one) of program modules that are configured to carry out the functions of embodiments of the invention.

The program/utility (40), having a set (at least one) of program modules (42), may be stored in the memory (28) by way of example, and not limitation, as well as an operating system, one or more application programs, other program modules, and program data. Each of the operating system, one or more application programs, other program modules, and program data or some combination thereof, may include an implementation of a networking environment. The program modules (42) generally carry out the functions and/or methodologies of embodiments of the invention as described herein. The computing device (12) may also communicate with one or more external devices (14) such as a keyboard, a pointing device, a display 24, etc.; one or more devices that enable a user to interact with the computing device (12); and/or any devices (e.g., network card, modem, etc.) that enable the computing device (12) to communicate with one or more other computing devices. Such communication can occur via Input/Output (I/O) interfaces (22). Still yet, the computing device (12) can communicate with one or more networks such as a local area network (LAN), a general wide area network (WAN), and/or a public network (e.g., the Internet) via the network adapter (20). As depicted, the network adapter (20) communicates with the other components of the computing device (12) via the bus (18). It should be understood that although not shown, other hardware and/or software components could be used in conjunction with computer system/server (12). Examples, include, but are not limited to: microcode, device drivers, redundant processing units, external disk drive arrays, RAID systems, tape drives, and data archival storage systems, etc.

As was described above, space and time can be generalized e.g., over multiple STBs, which each reflects a spatial region and time interval, at a specific granularity, that is, the STBs can be thought of as having several dimensions, such as a longitude dimension, a latitude dimension and a time dimension, for example. In some embodiments suitable for reflecting entities on the Earth's surface, the STBs for an observed event are created by using a geohash public-domain geospatial-quantizing algorithm, along with a simple time-quantizing algorithm (see http://en.wikipedia.org/wiki/Geohash). The STBs are represented as alphanumeric strings, where the length of the string represents the “granularity” of the STB; that is, a longer string represents a more precise geospatial region and time interval. These alphanumeric strings will be referred to below as “STB keys.” It should be noted that space and time can be represented by means other than alphanumeric strings, for example, bit vectors, and that the invention is not limited to embodiments that rely on the forms of space and time representation described herein.

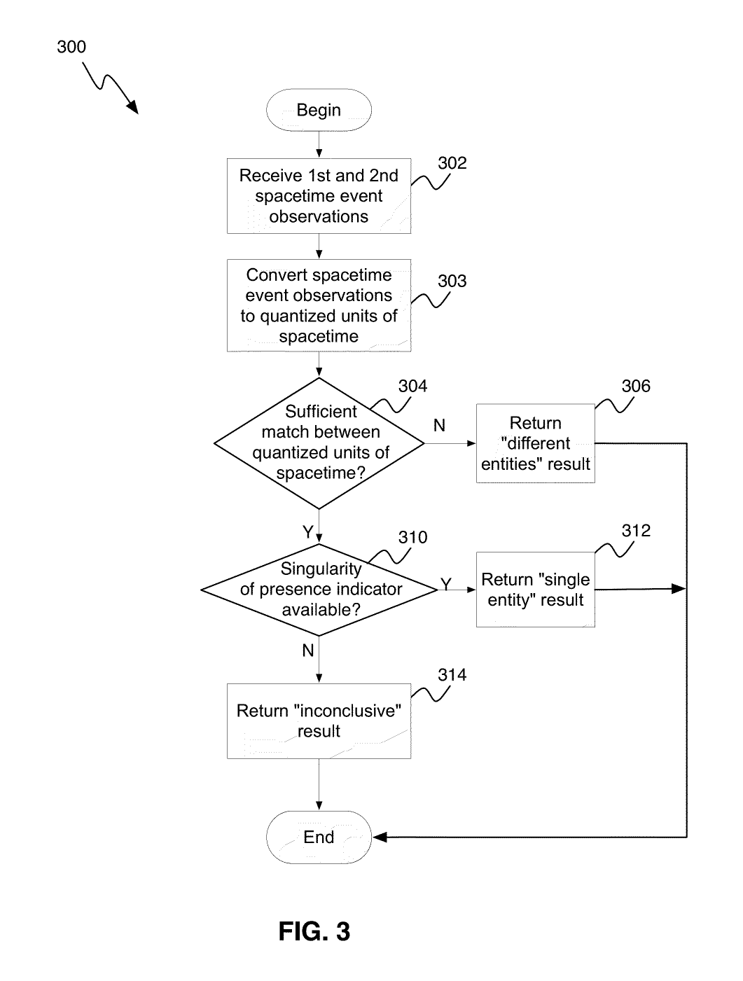

As was described above, in some cases, even fine-grained STBs, e.g., a meter squared, may not be sufficient to resolve whether two observations emanate from the same entity or from different entities. To make this determination, additional sources of observation can be used, which can provide a singularity of presence indicator that allows a singularity of presence determination to be made, as was discussed in the introductory examples above. An exemplary process for making such a determination will now be described with respect to the flowchart shown in FIG. 3. As can be seen in FIG. 3, the process starts by receiving two spacetime event observations (step 302). Typically, each spacetime event observation is contained in a data record, which may also contain some additional information about the observed event. Each observed event is associated with one or more quantized space features and time features, which can be configurable and which may be defined based on the precision of the observation. It should be noted that the two spacetime event observations rarely come at the same time, although sometimes they do. Most commonly, the event observations are separated by time, sometimes being even years apart.

Next, the received spacetime event observations are converted into quantized units of spacetime (step 303). One example of such a quantized unit of spacetime is the STBs described above. In some embodiments, the STBs can be represented by a quantized key, such as an alphanumeric string, as described above. Next, the quantized units of spacetime for the first and second events are compared with each other to determine whether they match sufficiently (step 304). In some embodiments, the comparison may involve, for example, comparing the longitude, latitude and time coordinates associated with each spacetime event observations. In other embodiments, for example, where quantized keys represent the STBs, the comparison may involve comparing the quantized keys representing the respective quantized units of spacetime, which may improve the efficiency of the comparison.

The criterion for what is considered to be a “sufficient match” in step 304 can typically be defined by a user, or be determined automatically depending on the nature of the spacetime event observations. For example, in some situations, it can be concluded that if there is not an exact match between two quantized units of spacetime with which two spacetime event observations are associated, then there is no possibility that the two spacetime event observations can belong to the same entity.

However, there may also be situations when there is not an exact match between two quantized units of spacetime with which two spacetime event observations are associated, then there still might be a possibility that the two spacetime event observations can belong to the same entity. For example, as time passes, entities transit into neighboring quantized units of spacetime (e.g., neighboring STBs), in this case moving along the time dimension only. In the case of a stationary object, for example, two spacetime event observations may have the same longitude and latitude coordinates, but different time coordinates, thus placing the spacetime observations into different quantized units of spacetime (since the time dimension has changed between the two spacetime event observations). There may also be situations when the reported location of a static entity appears to change (e.g., due to inaccuracies in the mechanisms that is used to determine the location of the static entity), or when an entity casually drifts or outright moves, between two spacetime event observations. This may also cause the spacetime event observations to be associated with different quantized units of spacetime, although they may still belong to the same entity. Therefore, it is important to have a clear definition of what is considered to be a “sufficient match” between two quantized units of spacetime. A sufficient match may, for example, be an exact match; it may be a match with an immediately neighboring quantized unit of spacetime; it may be a match with a neighboring quantized unit of spacetime that is located several steps away; it may be a match within a certain range of longitude, latitude and/or time coordinates, etc. As the skilled person realizes, essentially any type of matching criteria can be set up for what should define a “sufficient match” between two spacetime event observations.

If there is no sufficient match between the quantized units of spacetime for the first and second spacetime event observations, respectively, then the first and second spacetime event observations belong to different entities, and a “different entities” result is returned (step 306), which ends the process (300).

Otherwise, if it is determined in step 304 that there is a sufficient match between the two quantized units of spacetime, there is a possibility that the two spacetime event observations could either relate to the same entity or to two distinct entities. The process therefore examines whether there are any available supplemental singularity of presence indicators (step 310). Such indicators can include, for example, visual indicators (as in the examples above with the jet airplane observation, and the video feed from the ATM machine, respectively), location indicators for the single entity or for other entities (as in the example with the two roommates being out of town and with the sailboat moving on the ocean, respectively). It should be noted that in some embodiments, these singularity of presence indicators can be received together with the first and/or second spacetime event observations. For example, when looking across the water at the sailboat one has observed a spacetime event that can be quantized, while at the same time and in the same observation noting that there is only a single entity in the scene (i.e., the singularity of presence indicator is included in the spacetime event observation). In other embodiments, the singularity of presence indicator can be received separately from the first and/or spacetime event observations. Many variations can be envisioned by those of ordinary skill in the art. It should be further noted that these are merely a few examples of possible singularity of presence indicators. The same general principles apply to any type of indicator that can be used to determine singularity of presence.

It should be noted that when considering singularity of presence, singularity of presence indicators can be inherited from earlier (in time) quantized units of spacetime (such as STBs). This inheritance mechanism enables the singularity of presence indicator to out-survive the windowed (boundary) nature of a quantized unit of spacetime. By way of example, with no entity present in a quantized unit of spacetime, and an entity previously detected as singular entity entering the empty quantized unit of spacetime, the entity in the new quantized unit of spacetime retains (inherits) the singularity condition that had already been established from the previous quantized unit of spacetime. As another example, consider the above example with the observation of a boat at two different times. While these two observations might be represented in different quantized units of spacetime, the singularity of presence indicator available from the first observation (i.e., the visual determination that there is only a single boat on the ocean) can be inherited when the second observation of the boat is made in a different location on the ocean and at a different time. It should be noted that for the inheritance to work, there must be a singularity of presence indicator in the second observation as well (i.e., a visual determination that there is only a single boat on the ocean). If the second observation all of a sudden were to include many entities (e.g., several boats), then the inheritance would not transfer, as it would not be possible to determine which of the boats would inherit the properties from the first observation.

If it is determined in step 310 that there is an available singularity of presence indicator that can be associated with the first and second spacetime event observations, this means that the spacetime event observations actually belong to the same entity, and a “single entity” result is returned (step 312), which ends the process (300). On the other hand, if it is determined in step 310 that there is no singularity of presence indicator, then the process cannot conclude whether the two spacetime event observations belong to one entity or to different entities. Therefore, an “inconclusive” result is returned (step 314), which ends the process (300). Thus, while the process (300) cannot determine in every case whether two spacetime event observations can be asserted to be from a single entity or with separate entities, it improves the frequency with which events and entities can be asserted as same compared to if no singularity of presence information were used.

It should be noted that when considering “inheritance” of singularity of presence between two quantized units of spacetime, it is important that there is some degree of “continuity of view,” which can be represented by a continuity of view indicator. For example, if a boat is observed at a jetty every five minutes during a 24-hour period, it is reasonable to conclude that the boat that is observed at 8 a.m. on Day 1 is the same boat that is observed at 8 a.m. at the jetty on Day 2, and that it is appropriate for the singularity of presence to be inherited between the two quantized units of spacetime. However, if there is no continuity of view indicator, say, there is one observation at 8 a.m. on Day 1, another one at 11 p.m. on Day 1, and one at 8 a.m. on Day 2, then it may not be appropriate to assert sameness between the three observations. That is, the observations could possibly pertain to three different boats, which just happen to look the same and to be at the same location at the jetty at these times. It is impossible to know what happens between the observations, since there is no continuity of view indicator. Thus, in such a situation, it may not be appropriate to inherit the singularity of presence between the different quantized units of spacetime. For this reason, it is important to exercise caution when deciding whether to inherit singularity of presence indicators between two quantized units of spacetime.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-8. (canceled)

9. A computer-implemented method, comprising:
determining whether a first entity and a second entity are a same entity based on a singularity of presence indicator, a first spacetime region with which the first entity is associated, and a second spacetime region with which the second entity is associated.

10. A computer program product for processing data, the computer program product comprising a computer readable storage medium having program code embodied therewith, the program code executable by a processor to:
receive a first spacetime event observation;
receive a second spacetime event observation;
receive singularity of presence indicator for a zone of space and a range of time corresponding to one or more of: the first spacetime event observation and the second spacetime event observation; and
determine whether the first spacetime event observation and the second spacetime event observation belong to a same entity using the singularity of presence indicator.

11. The computer program product of claim 10, further comprising program code executable by a processor to:
make a business decision based at least in part on the first spacetime event observation and the second spacetime event observation belonging to the same entity.

12. The computer program product of claim 10, wherein the first spacetime observation is stored as a first data entity record and the second spacetime observation is stored as a second data entity record.

13. The computer program product of claim 12, wherein the singularity of presence indicator is contained in one or more of: the first entity data record and the second entity data record.

14. The computer program product of claim 10, wherein each of the first spacetime observation and second spacetime event observation is represented as a configurable quantized unit of space and time.

15. The computer program product of claim 10, wherein the singularity of presence indicator is further used to determine a class of entities associated with one of: the first event observation and the second event observation.

16. The computer program product of claim 10, wherein the singularity of presence indicator further is accompanied by a continuity of view indicator.

17. The computer program product of claim 10, wherein determining further comprises comparing a first quantized key associated with the first spacetime event observation and a second quantized key associated with the second spacetime event observation.
